(19) United States
(12) Patent Application Publication
(10) Pub. No.: US 2026/0188934 A1
(43) Pub. Date: Jul. 2, 2026

(54) CABLE CONNECTOR AND CONNECTOR ASSEMBLY WITH IMPROVED CONNECTION FEATURES OF POWER TERMINAL AND POWER CABLE

(71) Applicant: DONGGUAN XUNTAO ELECTRONIC CO., LTD., Dongguan City (CN)

(72) Inventor: Hongji CHEN, Dongguan City (CN)

(73) Assignee: DONGGUAN XUNTAO ELECTRONIC CO., LTD., Dongguan City (CN)

(21) Appl. No.: 19/289,709

(22) Filed: Aug. 4, 2025

(30) Foreign Application Priority Data
Dec. 26, 2024 (CN) 202423248553.7

(51) Int. Cl. H01R 13/42; H01R 13/512

(52) U.S. Cl. CPC H01R 13/42; H01R 13/512

(57) ABSTRACT

A cable connector includes a first insulating housing, a number of conductive terminals and a number of cables. The conductive terminals include a first power terminal and a second power terminal. The first power terminal includes a first contact portion and a first mounting portion. The second power terminal includes a second contact portion and a second mounting portion. The cables include a first power cable and a second power cable. The first power cable includes a first connection portion. The second power cable includes a second connection portion. The first connection portion is connected to the first mounting portion along a first direction. The second connection portion is connected to the second mounting portion along the first direction. A connector assembly having the cable connector is also disclosed.

### CROSS-REFERENCE TO RELATED APPLICATION

This patent application claims priority of a Chinese Patent Application No. 202423248553.7, filed on Dec. 26, 2024 and titled “CABLE CONNECTOR AND CONNECTOR ASSEMBLY”, the entire content of which is incorporated herein by reference.

### TECHNICAL FIELD

The present disclosure relates to a cable connector and a connector assembly, which belong to the technical field of connectors.

### BACKGROUND

A connector assembly in the related art generally includes a cable connector and a board-end connector mated with the cable connector. The cable connector includes a plurality of power terminals and a power cable connected to the power terminals. However, considering the outlet direction of the power cable, how to connect the power cable to the power terminals to save installation space and improve reliability is a technical problem faced by those skilled in the art.

Therefore, it is desirable to improve cable connectors and connector assemblies in related technologies.

### SUMMARY

An object of the present disclosure is to provide a cable connector and a connector assembly with improved structures.

The present disclosure adopts the following technical solution: a cable connector, including: a first insulating housing, the first insulating housing including a mating surface, a first receiving groove extending through the mating surface along a first direction, and a second receiving groove extending through the mating surface along the first direction; a plurality of conductive terminals, the plurality of conductive terminals including a first power terminal at least partially received in the first receiving groove and a second power terminal at least partially received in the second receiving groove; the first power terminal including a first contact portion and a first mounting portion; the second power terminal including a second contact portion and a second mounting portion; and a plurality of cables, the plurality of cables including a first power cable and a second power cable; the first power cable including a first connection portion located at one end of the first power cable; the second power cable including a second connection portion located at one end of the second power cable; the first connection portion being connected to the first mounting portion along the first direction; the second connection portion being connected to the second mounting portion along the first direction.

The present disclosure also adopts the following technical solution: a connector assembly, including: a cable connector including: a first insulating housing, the first insulating housing including a mating surface, a first receiving groove extending through the mating surface along a first direction, and a second receiving groove extending through the mating surface along the first direction; a plurality of conductive terminals, the plurality of conductive terminals including a first power terminal at least partially received in the first receiving groove and a second power terminal at least partially received in the second receiving groove; the first power terminal including a first contact portion and a first mounting portion; the second power terminal including a second contact portion and a second mounting portion; and a plurality of cables, the plurality of cables including a first power cable and a second power cable; the first power cable including a first connection portion; the second power cable including a second connection portion; the first connection portion being connected to the first mounting portion along the first direction; the second connection portion being connected to the second mounting portion along the first direction; and a mating connector configured to be mounted on a circuit board; the mating connector including an insulating body, a first mating power terminal fixed to the insulating body and a second mating power terminal fixed to the insulating body; when the cable connector is mated with the mating connector, the first power terminal is in contact with the first mating power terminal, and the second power terminal is in contact with the second mating power terminal.

### BRIEF DESCRIPTION OF DRAWINGS

FIG. 1 is a schematic perspective view of a connector assembly in accordance with an embodiment of the present disclosure;

FIG. 2 is a perspective view of FIG. 1 from another angle;

FIG. 3 is a partially exploded perspective view of FIG. 1, in which a cable connector and a mating connector are separated from each other;

FIG. 4 is a partially exploded perspective view of FIG. 3 from another angle;

FIG. 5 is a partially exploded perspective view of FIG. 3 from another angle;

FIG. 6 is a top view of the cable connector and the mating connector when they are separated from each other;

FIG. 7 is a bottom view of FIG. 6;

FIG. 8 is a partial enlarged view of frame part B in FIG. 6;

FIG. 9 is a partial enlarged view of frame part C in FIG. 7;

FIG. 10 is a right side view of the mating connector in FIG. 5;

FIG. 11 is an exploded perspective view of the mating connector in FIG. 5;

FIG. 12 is an exploded perspective view of FIG. 11 from another angle;

FIG. 13 is a partially exploded perspective view of the cable connector in accordance with the embodiment of the present disclosure;

FIG. 14 is a partially exploded perspective view of FIG. 13 from another angle;

FIG. 15 is a further partial perspective exploded view of the cable connector;

FIG. 16 is a partially exploded perspective view of FIG. 15 from another angle;

FIG. 17 is an exploded perspective view of a first insulating housing, a second insulating housing and a fastener in FIG. 15;

FIG. 18 is an exploded perspective view of FIG. 17 from another angle;

FIG. 19 is a front view when a first power terminal and a first power cable are connected together, and a second power terminal and a second power cable are connected together;

FIG. 20 is an exploded view of FIG. 19;

FIG. 21 is a further perspective exploded view after removing the first insulating housing, the second insulating housing and the fastener in FIG. 17;

FIG. 22 is an exploded perspective view of FIG. 21 from another angle;

FIG. 23 is a perspective view of the first power terminal, the second power terminal, a first signal terminal, a second signal terminal, the first power cable, the second power cable, a first signal cable and a second signal cable when they are separated from one another;

FIG. 24 is a perspective view of FIG. 23 from another angle;

FIG. 25 is a schematic cross-sectional view taken along line D-D in FIG. 1; and

FIG. 26 is a partial enlarged view of frame part E in FIG. 25.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

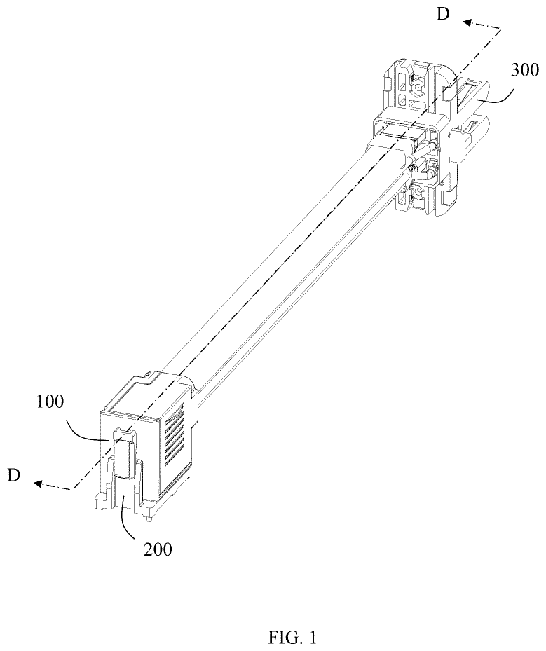

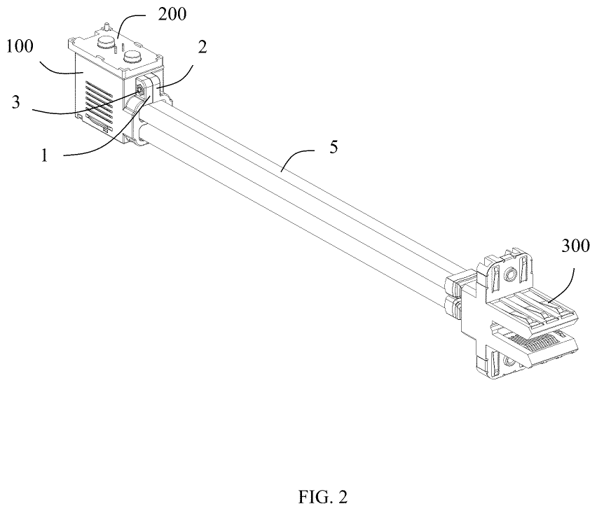

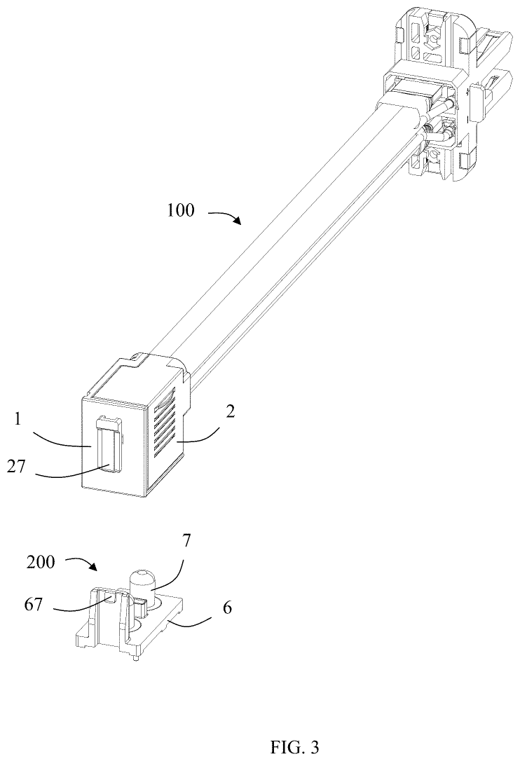

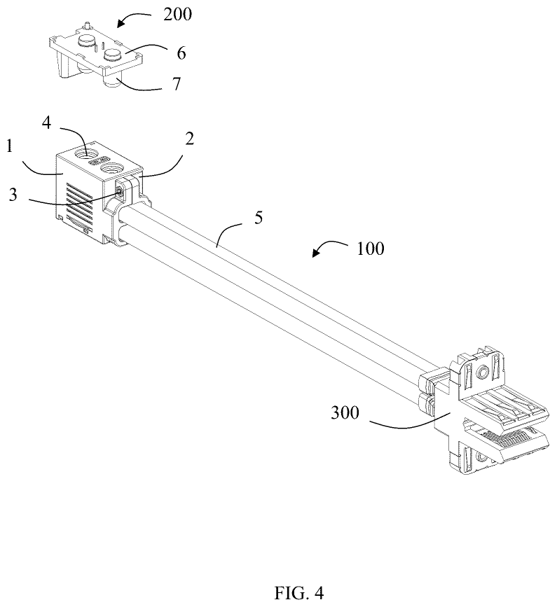

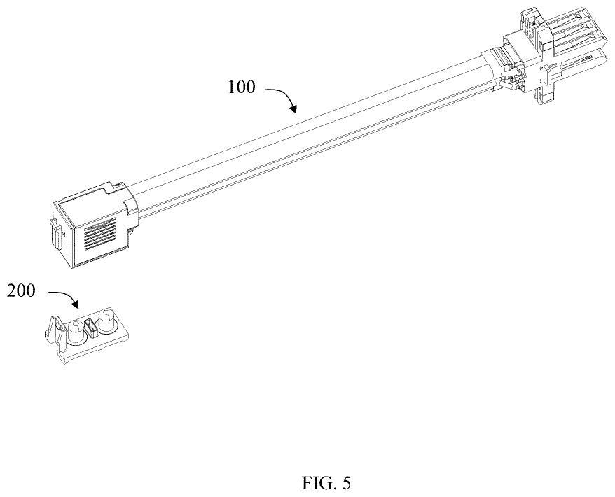

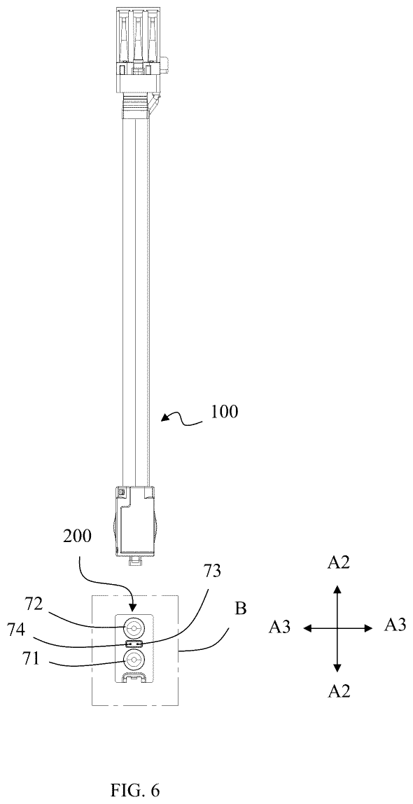

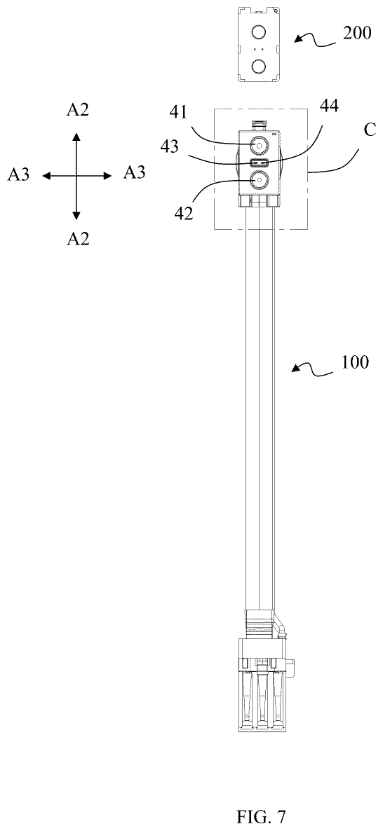

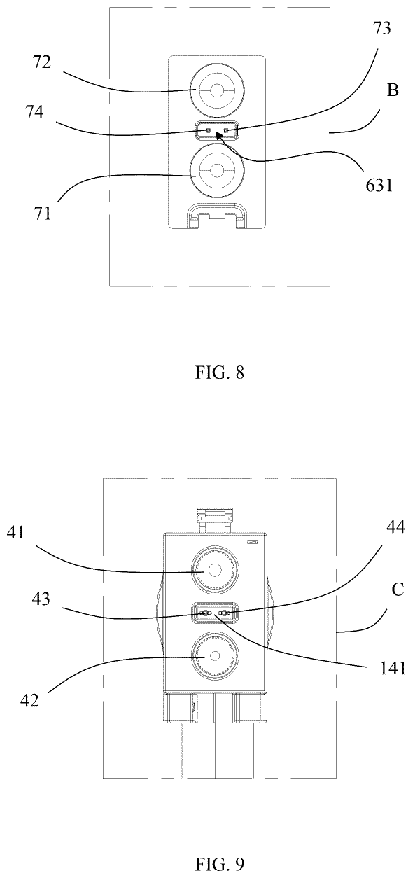

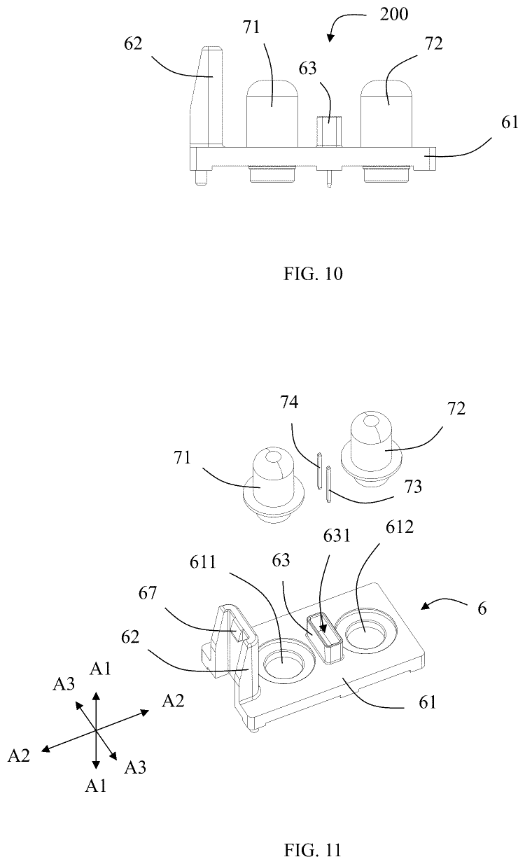

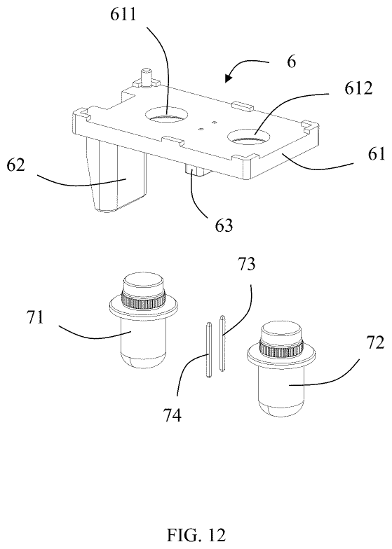

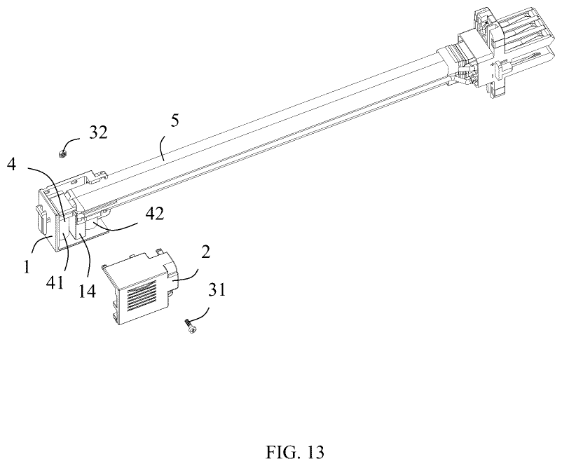

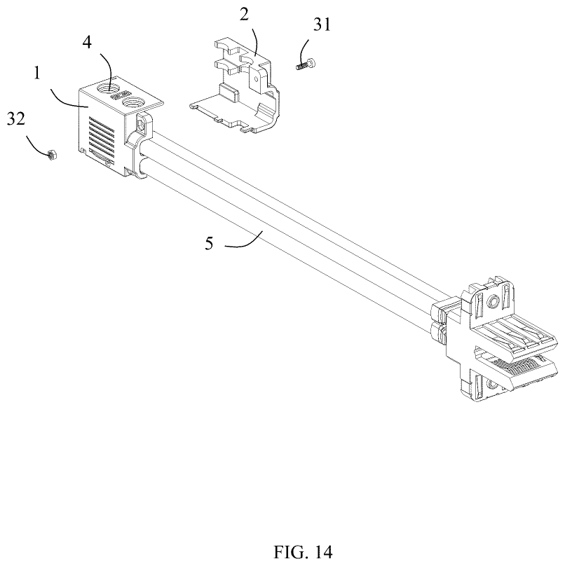

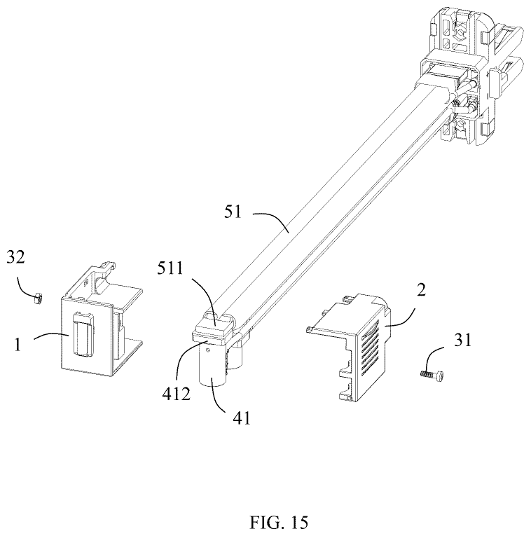

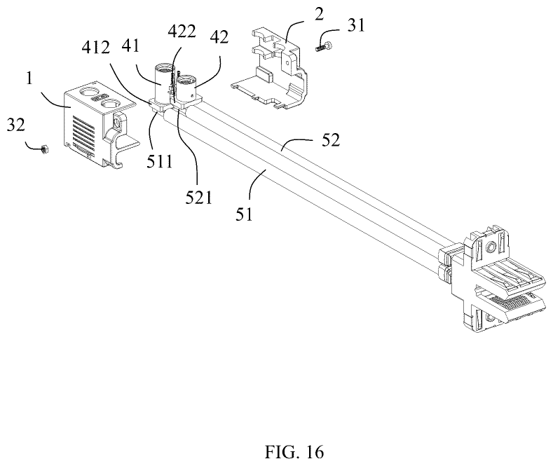

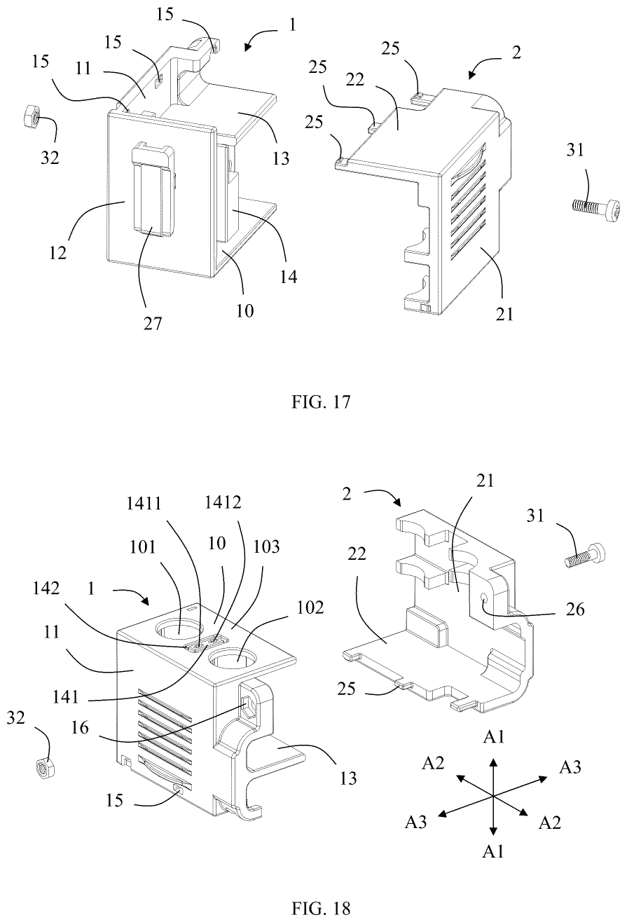

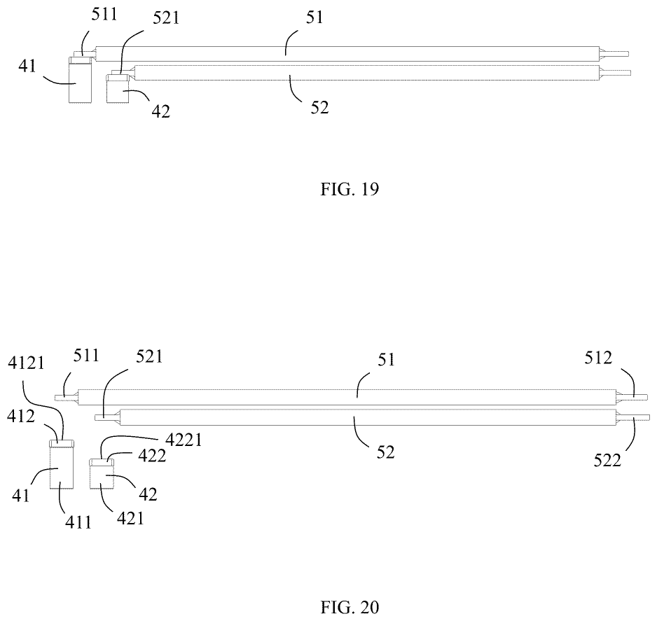

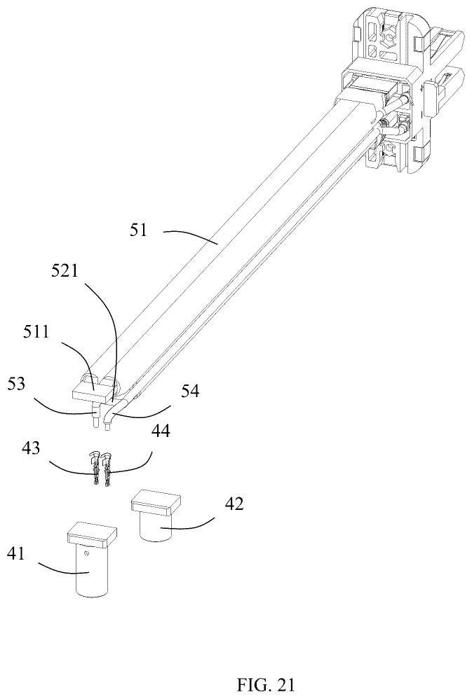

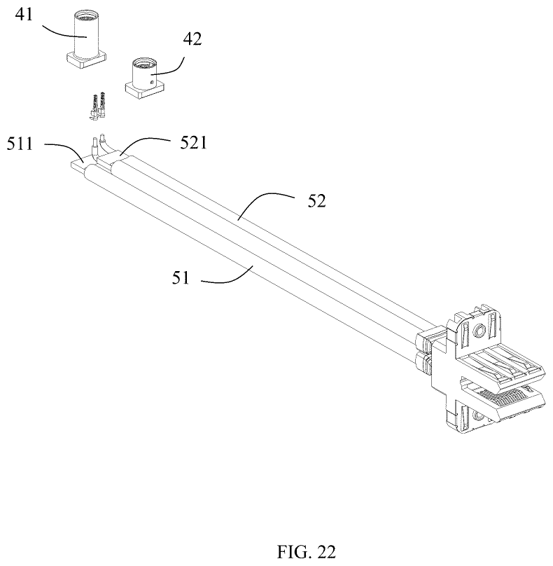

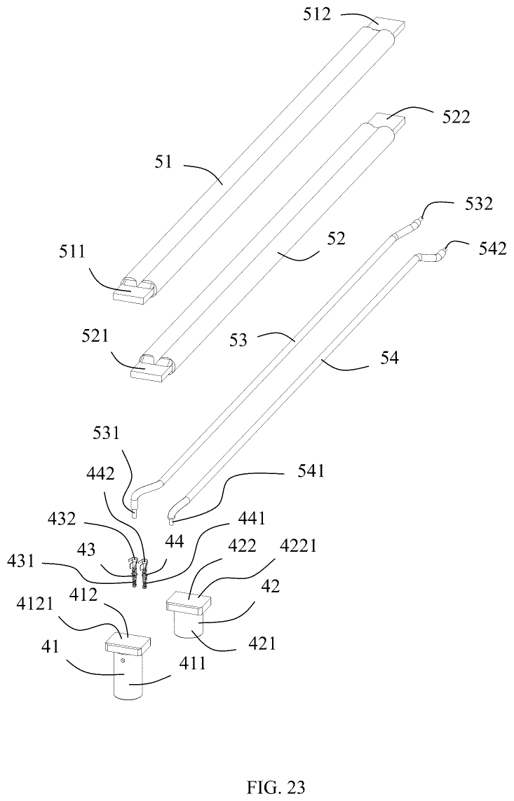

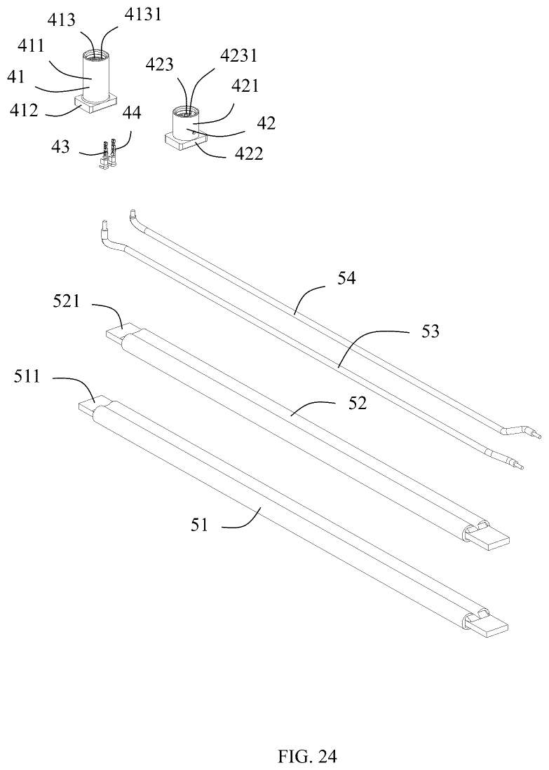

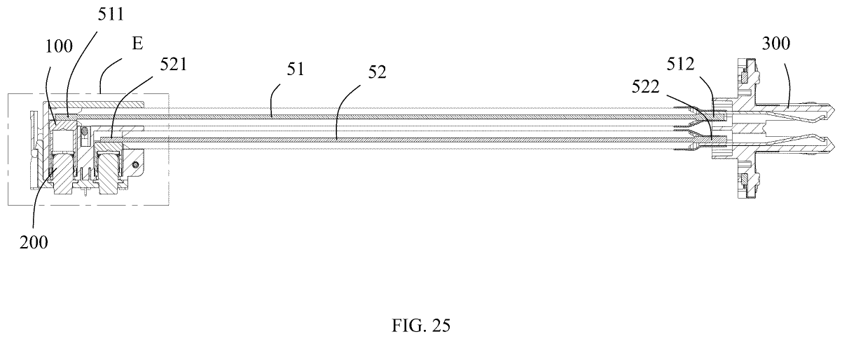

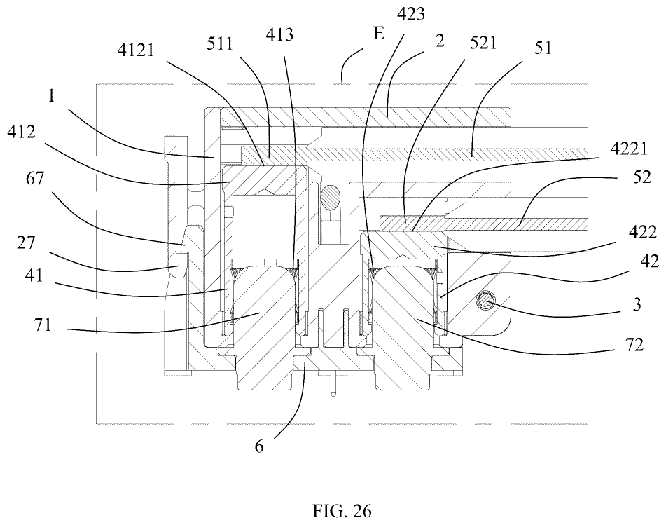

Referring to FIG. 1 to FIG. 26, the present disclosure discloses a connection assembly, which includes a cable connector 100 and a mating connector 200 mated with the cable connector 100. The mating connector 200 is configured to be mounted on a circuit board (not shown).

The cable connector 100 includes a first insulating housing 1, a second insulating housing 2 matched with the first insulating housing 1, a fastener 3 fixing the first insulating housing 1 and the second insulating housing 2 together, a plurality of conductive terminals 4 fixed to the first insulating housing 1, and a plurality of cables 5 connected to the plurality of conductive terminals 4.

The first insulating housing 1 includes a mating wall 10, a first side wall 11 connected to a first edge of the mating wall 10, a second side wall 12 connected to a second edge of the mating wall 10, a first extension wall 13 connected to the first side wall 11, and a partition wall 14 connected to the mating wall 10. In the illustrated embodiment of the present disclosure, each two of the mating wall 10, the first side wall 11 and the second side wall 12 are perpendicular to each other.

The mating wall 10 is provided with a mating surface 103. The first insulating housing 1 further includes a first receiving groove 101 extending through the mating surface 103 along a first direction A1-A1 (for example, a top-bottom direction), and a second receiving groove 102 extending through the mating surface 103 along the first direction A1-A1. The partition wall 14 is provided with a mating portion 141 and a mating slit 142 provided around the mating portion 141. The mating portion 141 defines a first terminal mounting hole 1411 and a second terminal mounting hole 1412. The first receiving groove 101 and the second receiving groove 102 are located on two sides of the partition wall 14, respectively, along a second direction A2-A2 (for example, a front-rear direction). The mating portion 141 is located between the first terminal mounting hole 1411 and the second terminal mounting hole 1412 along the second direction A2-A2. The first terminal mounting hole 1411 and the second terminal mounting hole 1412 are spaced apart along a third direction A3-A3 (for example, a left-right direction). Each two of the first direction A1-A1, the second direction A2-A2 and the third direction A3-A3 are perpendicular to each other.

The second insulating housing 2 includes a third side wall 21 disposed opposite to the first side wall 11, and a fourth side wall 22 extending from the third side wall 21. The fourth side wall 22 is fixed to the first side wall 11. The first extension wall 13 is supported on the third side wall 21. The first insulating housing 1 and the second insulating housing 2 are provided with a locking protrusion 15 and a locking hole 25 that cooperate with each other. In the illustrated embodiment of the present disclosure, the locking protrusion 15 is provided on a side of the fourth side wall 22 facing the first side wall 11. Correspondingly, the locking hole 25 is provided on the first side wall 11. The locking protrusion 15 is at least partially inserted into the locking hole 25 so that the fourth side wall 22 and the first side wall 11 are fixed to each other.

In the illustrated embodiment of the present disclosure, the fastener 3 includes a bolt 31 and a nut 32. The first insulating housing 1 defines a receiving hole 16 for receiving the nut 32. The second insulating housing 2 is provided with a mounting through hole 26. The bolt 31 passes through the mounting through hole 26 and is fixed with the nut 32. With this arrangement, the first insulating housing 1 and the second insulating housing 2 are reliably fixed together by the fastener 3.

The plurality of conductive terminals 4 include a first power terminal 41 at least partially received in the first receiving groove 101, a second power terminal 42 at least partially received in the second receiving groove 102, a first signal terminal 43 at least partially received in the first terminal mounting hole 1411, and a second signal terminal 44 at least partially received in the second terminal mounting hole 1412.

The first power terminal 41 includes a first contact portion 411 and a first mounting portion 412. The first mounting portion 412 is flat. The first mounting portion 412 is provided with a first mounting surface 4121. The first contact portion 411 is hollow cylindrical. In the illustrated embodiment of the present disclosure, the conductive terminal 4 further includes a first reed 413 received in the first contact portion 411. The first reed 413 is provided with a plurality of first elastic arm portions 4131 configured to abut against the mating connector 200.

In the illustrated embodiment of the present disclosure, the first mounting portion 412 is rectangular. A projection of the first contact portion 411 along the first direction A1-A1 completely falls within a range of the first mounting portion 412.

The second power terminal 42 includes a second contact portion 421 and a second mounting portion 422. The second mounting portion 422 is flat. The second mounting portion 422 is provided with a second mounting surface 4221. The second contact portion 421 is hollow cylindrical. In the illustrated embodiment of the present disclosure, the conductive terminal 4 further includes a second reed 423 received in the second contact portion 421. The second reed 423 is provided with a plurality of second elastic arm portions 4231 configured to abut against the mating connector 200.

In the illustrated embodiment of the disclosure, the second mounting portion 422 is rectangular. A projection of the second contact portion 421 along the first direction A1-A1 completely falls within a range of the second mounting portion 422.

The first signal terminal 43 includes a third contact portion 431 and a third mounting portion 432 connected to the third contact portion 431.

The second signal terminal 44 includes a fourth contact portion 441 and a fourth mounting portion 442 connected to the fourth contact portion 441.

The plurality of cables 5 include a first power cable 51, a second power cable 52, a first signal cable 53 and a second signal cable 54.

The first power cable 51 includes a first connection portion 511 located at one end of the first power cable 51. The first connection portion 511 is connected to the first mounting portion 412 along the first direction A1-A1. Specifically, the first connection portion 511 is flat. The first connection portion 511 is disposed above the first mounting surface 4121 along the first direction A1-A1 and is in contact with the first mounting surface 4121. In an embodiment of the present disclosure, the first connection portion 511 and the first mounting portion 412 are fixed together by soldering or welding.

Similarly, the second power cable 52 includes a second connection portion 521 located at one end of the second power cable 52. The second connection portion 521 is connected to the second mounting portion 422 along the first direction A1-A1. Specifically, the second connection portion 521 is flat. The second connection portion 521 is disposed above the second mounting surface 4221 along the first direction A1-A1 and is in contact with the second mounting surface 4221. In an embodiment of the present disclosure, the second connection portion 521 and the second mounting portion 422 are fixed together by soldering or welding. In the illustrated embodiment of the present disclosure, the first mounting surface 4121 and the second mounting surface 4221 are located at different heights along the first direction A1-A1. For example, the first mounting surface 4121 is higher than the second mounting surface 4221 along the first direction A1-A1. With this arrangement, the first power cable 51 and the second power cable 52 can avoid interference in the first direction A1-A1.

The first signal cable 53 includes a third connection portion 531 connected (for example, fixed by soldering or welding) to the third mounting portion 432. The second signal cable 54 includes a fourth connection portion 541 connected (for example, fixed by soldering or welding) to the fourth mounting portion 442.

In the illustrated embodiment of the present disclosure, the first power cable 51 and the second power cable 52 extend out of the first insulating housing 1 and the second insulating housing 2 along the second direction A2-A2. The cable connector 100 of the present disclosure can utilize a space in the first direction A1-A1 to realize the connection between the first power cable 51 and the first power terminal 41, and the connection between the second power cable 52 and the second power terminal 42, thereby saving space and improving reliability.

In addition, in the illustrated embodiment of the present disclosure, both the first connection portion 511 and the second connection portion 521 are flat. Such arrangement is beneficial to increasing the contact area between the first connection portion 511 and the first mounting surface 4121, and is beneficial to increasing the contact area between the second connection portion 521 and the second mounting surface 4221, thereby improving reliability.

In the illustrated embodiment of the present disclosure, the first power cable 51 further includes a first mating portion 512 disposed opposite to the first connection portion 511. The second power cable 52 further includes a second mating portion 522 disposed opposite to the second connection portion 521. The first signal cable 53 further includes a third mating portion 532 disposed opposite to the third connection portion 531. The second signal cable 54 further includes a fourth mating portion 542 disposed opposite to the fourth connection portion 541. The first mating portion 512 and the second mating portion 522 are also flat. The first mating portion 512, the second mating portion 522, the third mating portion 532 and the fourth mating portion 542 are all connected to a connector joint 300.

The mating connector 200 includes an insulating body 6 and a plurality of mating conductive terminals 7 fixed to the insulating body 6.

The insulating body 6 includes a base plate 61, a protruding portion 62 protruding upwardly from one end of the base plate 61 along the first direction A1-A1, and a frame portion 63 protruding upwardly from a middle portion of the base plate 61 along the first direction A1-A1. The base plate 61 defines a first mounting hole 611 and a second mounting hole 612 which are spaced apart from each other along the second direction A2-A2. In the illustrated embodiment of the present disclosure, the first mounting hole 611 and the second mounting hole 612 both extend through the base plate 61 along the first direction A1-A1. The frame portion 63 is located between the first mounting hole 611 and the second mounting hole 612 along the second direction A2-A2. The frame portion 63 has a surrounding structure and is provided with an internal space 631. The frame portion 63 is configured to be inserted into the mating slit 142 of the cable connector 100. At the same time, the mating portion 141 of the cable connector 100 is configured to be inserted into the internal space 631.

The first insulating housing 1 of the cable connector 100 and the insulating body 6 of the mating connector 200 are provided with a locking arm 27 and a locking protrusion 67 that interlock with each other.

In the illustrated embodiment of the present disclosure, the locking arm 27 is provided on the second side wall 12 of the cable connector 100. The locking protrusion 67 is provided on the protruding portion 62 of the mating connector 200. Of course, it is understandable to those skilled in the art that the locking arm 27 can also be provided on the protruding portion 62 of the mating connector 200, while the locking protrusion 67 is provided on the second side wall 12 of the cable connector 100.

The plurality of mating conductive terminals 7 include a first mating power terminal 71 at least partially fixed in the first mounting hole 611, a second mating power terminal 72 at least partially fixed in the second mounting hole 612, a first mating signal terminal 73 fixed to the insulating body 6 and protruding into the internal space 631, and a second mating signal terminal 74 fixed to the insulating body 6 and protruding into the internal space 631.

When the cable connector 100 is mated with the mating connector 200, the first power terminal 41 is in contact with the first mating power terminal 71; the second power terminal 42 is in contact with the second mating power terminal 72; the first signal terminal 43 is in contact with the first mating signal terminal 73; and the second signal terminal 44 is in contact with the second mating signal terminal 74.

Compared with the prior art, the cable connector 100 of the present disclosure includes the first power terminal 41, the second power terminal 42, the first power cable 51 and the second power cable 52. The first power terminal 41 includes the first contact portion 411 and the first mounting portion 412. The second power terminal 42 includes the second contact portion 421 and the second mounting portion 422. The first power cable 51 includes the first connection portion 511 located at one end of the first power cable 51. The second power cable 52 includes the second connection portion 521 located at one end of the second power cable 52. The first connection portion 511 is connected to the first mounting portion 412 along the first direction A1-A1. The second connection portion 521 is connected to the second mounting portion 422 along the first direction A1-A1. With this arrangement, the cable connector 100 of the present disclosure can utilize the space in the first direction A1-A1 to realize the connection between the first power terminal 41 and the first power cable 51, and the connection between the second power terminal 42 and the second power cable 52, which is beneficial to saving space and improving reliability.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable connector, comprising:
a first insulating housing, the first insulating housing comprising a mating surface, a first receiving groove extending through the mating surface along a first direction, and a second receiving groove extending through the mating surface along the first direction;
a plurality of conductive terminals, the plurality of conductive terminals comprising a first power terminal at least partially received in the first receiving groove and a second power terminal at least partially received in the second receiving groove; the first power terminal comprising a first contact portion and a first mounting portion; the second power terminal comprising a second contact portion and a second mounting portion; and
a plurality of cables, the plurality of cables comprising a first power cable and a second power cable; the first power cable comprising a first connection portion located at one end of the first power cable; the second power cable comprising a second connection portion located at one end of the second power cable; the first connection portion being connected to the first mounting portion along the first direction; the second connection portion being connected to the second mounting portion along the first direction.

2. The cable connector according to claim 1, wherein the first mounting portion is provided with a first mounting surface; the first connection portion is flat and in contact with the first mounting surface along the first direction;
the second mounting portion is provided with a second mounting surface; the second connection portion is flat and in contact with the second mounting surface along the first direction.

3. The cable connector according to claim 1, wherein the first mounting portion is flat and the first contact portion is hollow cylindrical;
the second mounting portion is flat and the second contact portion is hollow cylindrical.

4. The cable connector according to claim 3, wherein the plurality of conductive terminals comprise a first reed received in the first contact portion and a second reed received in the second contact portion; the first reed is provided with a plurality of first spring arm portions configured to contact a mating connector; the second reed is provided with a plurality of second elastic arm portions configured to contact the mating connector.

5. The cable connector according to claim 3, wherein a projection of the first contact portion along the first direction completely falls within a range of the first mounting portion; a projection of the second contact portion along the first direction completely falls within a range of the second mounting portion.

6. The cable connector according to claim 1, wherein the first power terminal and the second power terminal are spaced apart along a second direction;
the plurality of conductive terminals further comprise a first signal terminal installed in the first insulating housing and a second signal terminal installed in the first insulating housing; the first signal terminal and the second signal terminal are spaced apart along a third direction;
the plurality of cables comprise a first signal cable connected to the first signal terminal and a second signal cable connected to the second signal terminal;
each two of the first direction, the second direction and the third direction are perpendicular to each other.

7. The cable connector according to claim 6, wherein the first insulating housing comprises a mating wall and a partition wall connected to the mating wall; the mating surface is provided on the mating wall; the first receiving groove and the second receiving groove are located on two sides of the partition wall, respectively; the partition wall is provided with a mating portion and a mating slit disposed around the mating portion; the mating portion defines a first terminal mounting hole to mount the first signal terminal and a second terminal mounting hole to mount the second signal terminal.

8. The cable connector according to claim 1, further comprising a second insulating housing mated with the first insulating housing and a fastener fixing the first insulating housing and the second insulating housing together; the first insulating housing and the second insulating housing being provided with a locking protrusion and a locking hole that cooperate with each other.

9. The cable connector according to claim 8, wherein the fastener comprises a bolt and a nut; the first insulating housing defines a receiving hole to receive the nut; the second insulating housing 2 defines a mounting through hole; the bolt passes through the mounting through hole and is fixed with the nut.

10. A connector assembly, comprising:
a cable connector comprising:
a first insulating housing comprising a mating surface, a first receiving groove extending through the mating surface along a first direction, and a second receiving groove extending through the mating surface along the first direction;
a plurality of conductive terminals comprising a first power terminal at least partially received in the first receiving groove and a second power terminal at least partially received in the second receiving groove; the first power terminal comprising a first contact portion and a first mounting portion; the second power terminal comprising a second contact portion and a second mounting portion; and
a plurality of cables comprising a first power cable and a second power cable; the first power cable comprising a first connection portion; the second power cable comprising a second connection portion; the first connection portion being connected to the first mounting portion along the first direction; the second connection portion being connected to the second mounting portion along the first direction; and
a mating connector configured to be mounted on a circuit board; the mating connector comprising an insulating body, a first mating power terminal fixed to the insulating body and a second mating power terminal fixed to the insulating body;
when the cable connector is mated with the mating connector, the first power terminal is in contact with the first mating power terminal, and the second power terminal is in contact with the second mating power terminal.

11. The connector assembly according to claim 10, wherein the first insulating housing and the insulating body are provided with a locking arm and a locking protrusion that interlock with each other.

12. The connector assembly according to claim 10, wherein the first mounting portion is provided with a first mounting surface; the first connection portion is flat and in contact with the first mounting surface along the first direction;
the second mounting portion is provided with a second mounting surface; the second connection portion is flat and in contact with the second mounting surface along the first direction.

13. The connector assembly according to claim 10, wherein the first mounting portion is flat and the first contact portion is hollow cylindrical;
the second mounting portion is flat and the second contact portion is hollow cylindrical.

14. The connector assembly according to claim 13, wherein the plurality of conductive terminals comprise a first reed received in the first contact portion and a second reed received in the second contact portion; the first reed is provided with a plurality of first spring arm portions configured to contact a mating connector; the second reed is provided with a plurality of second elastic arm portions configured to contact the mating connector.

15. The connector assembly according to claim 13, wherein a projection of the first contact portion along the first direction completely falls within a range of the first mounting portion; a projection of the second contact portion along the first direction completely falls within a range of the second mounting portion.

16. The connector assembly according to claim 10, wherein the first power terminal and the second power terminal are spaced apart along a second direction;
the plurality of conductive terminals further comprise a first signal terminal installed in the first insulating housing and a second signal terminal installed in the first insulating housing; the first signal terminal and the second signal terminal are spaced apart along a third direction;
the plurality of cables comprise a first signal cable connected to the first signal terminal and a second signal cable connected to the second signal terminal;
each two of the first direction, the second direction and the third direction are perpendicular to each other.

17. The connector assembly according to claim 16, wherein the first insulating housing comprises a mating wall and a partition wall connected to the mating wall; the mating surface is provided on the mating wall; the first receiving groove and the second receiving groove are located on two sides of the partition wall, respectively; the partition wall is provided with a mating portion and a mating slit disposed around the mating portion; the mating portion defines a first terminal mounting hole to mount the first signal terminal and a second terminal mounting hole to mount the second signal terminal.

18. The connector assembly according to claim 10, wherein the cable connector further comprises a second insulating housing mated with the first insulating housing and a fastener fixing the first insulating housing and the second insulating housing together; the first insulating housing and the second insulating housing are provided with a locking protrusion and a locking hole that cooperate with each other.

19. The connector assembly according to claim 18, wherein the fastener comprises a bolt and a nut; the first insulating housing defines a receiving hole to receive the nut; the second insulating housing 2 defines a mounting through hole; the bolt passes through the mounting through hole and is fixed with the nut.

20. The connector assembly according to claim 10, wherein the first connection portion and the first mounting portion are fixed together by soldering or welding; and
the second connection portion and the second mounting portion are fixed together by soldering or welding.
